(19) United States
(12) Patent Application Publication
(10) Pub. No.: US 2025/0201842 A1
(43) Pub. Date: Jun. 19, 2025

(54) Electrode

(71) Applicant: TOYOTA JIDOSHA KABUSHIKI KAISHA, Toyota-shi Aichi-ken (JP)

(72) Inventor: Chika NOGUCHI, Toyota-shi Aichi-ken (JP)

(73) Assignee: TOYOTA JIDOSHA KABUSHIKI KAISHA, Toyota-shi Aichi-ken (JP)

(21) Appl. No.: 18/982,342

(22) Filed: Dec. 16, 2024

(30) Foreign Application Priority Data
Dec. 18, 2023 (JP) 2023-212800

(51) Int. Cl. H01M 4/62; H01M 4/02; H01M 4/36; H01M 4/38; H01M 4/587

(52) U.S. Cl. CPC H01M 4/62; H01M 4/366; H01M 4/386; H01M 4/587; H01M 2004/027

(57) ABSTRACT

An electrode includes a substrate and a negative electrode active material layer. The negative electrode active material layer is disposed on a surface of the substrate. The negative electrode active material layer includes a first active material particle and a second active material particle. The first active material particle includes graphite. The second active material particle includes silicon. In a cross section parallel to a thickness direction of the negative electrode active material layer, the first active material particle has a first orientation angle of 50° or more. The second active material particle has a second orientation angle of 35° or more. The first orientation angle indicates an angle formed between a major axis of the first active material particle and the surface of the substrate. The second orientation angle indicates an angle formed between a major axis of the second active material particle and the surface of the substrate.

### CROSS REFERENCE TO RELATED APPLICATIONS

This nonprovisional application is based on Japanese Patent Application No. 2023-212800 filed on Dec. 18, 2023 with the Japan Patent Office, the entire contents of which are hereby incorporated by reference.

### BACKGROUND

### Field

The present disclosure relates to an electrode.

### Description of the Background Art

JP 2017-050203A discloses a negative electrode containing a silicon alloy containing titanium and graphite.

### SUMMARY

A technique of orienting graphite in a negative electrode active material layer by a magnetic field has been known. By the application of magnetic field, the graphite can be oriented such that the major axes of particles thereof are along a thickness direction of the negative electrode active material layer. With the graphite oriented, a tortuosity factor (also referred to as a “tortuosity”) of an ion diffusion path can be reduced. By reducing the tortuosity factor, ion diffusion can be promoted in the thickness direction of the negative electrode active material layer. As a result, for example, improvement in cycle endurance is expected.

In order to attain a large capacity, a mixed system of graphite and silicon (Si) has been considered. As compared with a single system of graphite, the mixed system of graphite and Si tends to attain a small performance improvement effect in response to application of a magnetic field.

An object of the present disclosure is to improve cycle endurance.
1. An electrode includes a substrate and a negative electrode active material layer. The negative electrode active material layer is disposed on a surface of the substrate. The negative electrode active material layer includes a first active material particle and a second active material particle. The first active material particle includes graphite. The second active material particle includes silicon. In a cross section parallel to a thickness direction of the negative electrode active material layer, the first active material particle has a first orientation angle of 50° or more. The second active material particle has a second orientation angle of 35° or more. The first orientation angle indicates an angle formed between a major axis of the first active material particle and the surface of the substrate. The second orientation angle indicates an angle formed between a major axis of the second active material particle and the surface of the substrate.

The “orientation angle” is an index of an orientation state. The orientation angle can have a value of 0 to 90°. It is indicated that as the orientation angle is closer to 90°, the particle is oriented more strongly in the thickness direction of the negative electrode active material layer.

It is considered that one cause for the small performance improvement effect in the mixed system of graphite and Si in response to the application of magnetic field is that Si is less likely to respond to a magnetic field. That is, it is considered that since Si is not sufficiently oriented, the tortuosity factor is less likely to be reduced as a whole. To address this, the orientation angle of 50° or more is provided to the first active material particle (graphite), and the orientation angle of 35° or more is also provided to the second active material particle (Si). As a result, the tortuosity factor can be reduced also in the mixed system of graphite and Si. That is, improvement in cycle endurance is expected.
2. The electrode according to “1” may include, for example, the following configuration. The second active material particle includes a core particle and a magnetic material. The core particle includes silicon. The magnetic material is adhered to at least a portion of the core particle.

Since the magnetic material is adhered to the core particle, the magnetic field responsiveness is expected to be improved.
3. The electrode according to “2” may include, for example, the following configuration. The magnetic material includes at least one selected from a group consisting of titanium, zirconium, and vanadium. A ratio of an adhesion area of the magnetic material to a surface area of the second active material particle is 35% or more.

Each of titanium (Ti), zirconium (Zr) and vanadium (V) can have magnetic field responsiveness. Hereinafter, the ratio of the adhesion area of the magnetic material to the surface area of the second active material particle is also referred to as “coverage”. When the coverage is 35% or more, improvement in magnetic field responsiveness is expected.
4. The electrode according to any one of “1” to “3” may include, for example, the following configuration. The first active material particle has an aspect ratio of 4.3 to 9.5.

When the aspect ratio of the first active material particle (graphite) is 4.3 or more, improvement in magnetic field responsiveness is expected. As the aspect ratio of the first active material particle is larger, the first active material particle tend to be more likely to shift during a charging/discharging cycle. That is, in response to great expansion of the second active material particle (Si), the first active material particle (graphite), which is thin, tends to be pushed away to deviate the position of the first active material particle in an in-plane direction. The in-plane direction indicates any direction orthogonal to the thickness direction. Due to the shift of the first active material particle, the tortuosity factor can be increased. When the aspect ratio of the first active material particle is 9.5 or less, the first active material particle can have an appropriate thickness. When the first active material particle has an appropriate thickness, the first active material particle is expected to be less likely to shift.
5. The electrode according to any one of “1” to “4” may include, for example, the following configuration. The first orientation angle is 58° or more. A ratio of the first orientation angle to the second orientation angle is 1.40 or less.

When the first orientation angle is 58° or more, the tortuosity factor is expected to be reduced. Hereinafter, the ratio of the first orientation angle to the second orientation angle is also referred to as an “orientation angle ratio”. When the orientation angle ratio is 1.40 or less, the tortuosity factor is expected to be reduced.

Hereinafter, one embodiment of the present disclosure (hereinafter, simply referred to as “the present embodiment”) and one example of the present disclosure (hereinafter, simply referred to as “the present example”) will be described. It should be noted that the present embodiment and the present example do not limit the technical scope of the present disclosure. The present embodiment and the present example are illustrative in any respect. The present embodiment and the present example are non-restrictive. The technical scope of the present disclosure includes all the modifications within the meaning and scope equivalent to the descriptions of claims. For example, it is also initially expected to freely extract configurations from the present embodiment and combine them freely.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an explanatory view of an orientation angle.

FIG. 2 is a conceptual diagram illustrating an electrode according to the present embodiment.

FIG. 3 is a table showing experimental results.

### DESCRIPTION OF THE EMBODIMENTS

### Terms and Phrases

The “aspect ratio” indicates the ratio of the major axis diameter to the minor axis diameter. The major axis diameter indicates the maximum Feret diameter. The minor axis diameter indicates the minimum Feret diameter. The maximum Feret diameter and the minimum Feret diameter of the particles are measured in a cross-sectional SEM (Scanning Electron Microscope) image of the negative electrode active material layer. The maximum Feret diameter and the minimum Feret diameter may be determined by the image analysis software. The cross section is parallel to the thickness direction of the negative electrode active material layer. The observation magnification can be adjusted according to the size of the particles. The observation magnification is, for example, 700 times.

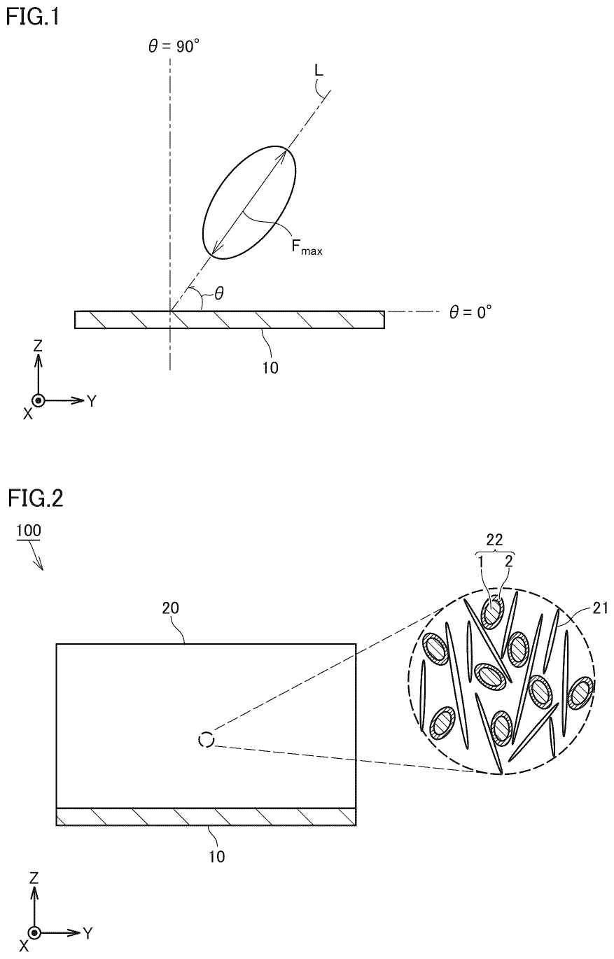

The “orientation angle” is measured by the following procedure. Five cross-sectional SEM images of the negative electrode active material layer were prepared. The five cross-sectional SEM images are imaged at different locations. FIG. 1 is an explanatory view of an orientation angle. In the image, the major axis L of the particle is identified. The major axis L is a straight line that passes through the maximum Feret diameter Fₘₐₓ of the particle. An angle θ formed by the major axis L and the surface of the substrate 10 is an orientation angle. The orientation angle is on the acute angle side. The orientation angle may take a value of 0 to 90°. The orientation angle may be determined by image analysis software. In the five cross-sectional SEM images, the average value of the orientation angles of the first active material particles is “first orientation angle (θ1). In the five cross-sectional SEM images, the average value of the orientation angles of the second active material particles is “second orientation angle (θ2). Particles whose major axes are difficult to specify due to deformation (crushing, cracking, or the like) of the particles may be excluded from the measurement targets. The same applies to the following “particle sizes” and the like.

The “particle size” indicates the average value of the maximum Feret diameters. For example, in the five cross-sectional SEM images, the average value of the maximum Feret diameters of the first active material particles is regarded as the “particle size of the first active material particles”. The same applies to the particle size of the second active material particles.

The “coverage” indicates the ratio of the adhesion area of the magnetic material to the surface area of the second active material particles. The coverage is measured by the following procedure. An SEM image of the second active material particles is prepared. Black is assigned to (a) Si and (b) voids in the SEM image. According to the threshold values determined in (a) and (b), the SEM image is binarized. In the image after the binarization processing, the coverage (S2/S1) is obtained by dividing the area (S2) of the magnetic material in the region by the area (S1) of the region surrounded by the contour line of the particle. Coverage is expressed in percentage. An average value of the coverages of 10 or more second active material particles is employed.

Elements expressed in the singular also include the plural unless specifically stated otherwise. For example, “particles” include not only “one particle” but also “a plurality of particles (particle groups)” and “collection of particles (powder)”.

The stoichiometric formula represents a representative example of a compound. The compound may have a non-stoichiometric composition. For example, “SiO” is not limited to a compound having an amount-of-substance ratio (molar ratio) of “Si:O=1:1”. “SiO” means a compound containing Si and O in any molar ratio unless otherwise specified. For example, the compound may be doped with a trace element. A part of Si and O may be substituted with another element.

Geometric terms are not to be construed in a strict sense. Examples of geometric terms include “parallel”, “perpendicular”, and “orthogonal”. For example, “parallel” may deviate somewhat from “parallel” in a strict sense. Geometric terms may include, for example, tolerances, errors, etc., in design, work, manufacturing, etc. The dimensional relationship in each drawing may not coincide with the actual dimensional relationship. To aid the reader's understanding, the dimensional relationships in the figures may be varied. For example, the length, width, thickness, and the like may be changed. Some components may be omitted.

Numerical ranges such as “m to n %” include upper and lower limits unless otherwise specified. That is, “m to n %” indicates a numerical range of “m % or more and n % or less”. Further, “m % or more and n % or less” includes “more than m % and less than n %”. The expressions “or more” and “or less” are represented by an inequality sign “≤” with an equal sign. “More than” and “less than” are represented by an inequality sign “<” that does not include an equal sign.

### —Electrode—

FIG. 2 is a conceptual diagram illustrating an electrode according to the present embodiment. In FIG. 2, the Z-axis direction is the thickness direction. Each of the X-axis direction and the Y-axis direction is one example of an in-plane direction. The electrode 100 is for a battery. The electrode 100 may be, for example, a negative electrode for a monopolar battery. The electrode 100 may be for a bipolar battery, for example. The electrode 100 may be for a liquid-based lithium ion battery, for example. The electrode 100 may be for an all-solid-state lithium ion battery, for example. The electrode 100 includes a substrate 10 and a negative electrode active material layer 20.

### Substrate

The substrate 10 supports the negative electrode active material layer 20. The substrate 10 may be in the form of a sheet, for example. The thickness of the substrate 10 may be, for example, 1 to 50 μm, or 5 to 30 μm. The substrate 10 has conductivity. The substrate 10 may include, for example, a metal foil or the like. The substrate 10 may include, for example, at least one selected from the group consisting of copper (Cu), nickel (Ni), zinc (Zn), lead (Pb), aluminum (Al), Ti, iron (Fe), silver (Ag), gold (Au), and a conductive resin. The substrate 10 may include, for example, a Cu foil, a Cu alloy foil, or the like. The substrate 10 may have, for example, a multilayer structure. For example, the substrate 10 may be formed by bonding a Cu foil and an Al foil.

### Negative Electrode Active Material Layer

The negative electrode active material layer 20 is disposed on the surface of the substrate 10. The negative electrode active material layer 20 may be disposed on only one surface of the substrate 10. The negative electrode active material layer 20 may be disposed on both surfaces of the substrate 10. When the electrode 100 is for a bipolar battery, the negative electrode active material layer 20 may be disposed on one surface (front surface) of the substrate 10, and the positive electrode active material layer (not shown) may be disposed on the other surface (rear surface). The thickness of the negative electrode active material layer 20 may be, for example, 10 to 1000 μm, or 100 to 500 μm.

The negative electrode active material layer 20 includes first active material particles 21 and second active material particles 22. The first active material particles 21 and the second active material particles 22 are negative electrode active materials. The mass fraction of the second active material particles 22 with respect to the total mass of the first active material particles 21 and the second active material particles 22 may be, for example, 1% or more, 3% or more, 5% or more, 10% or more, 15% or more, 20% or more, or 25% or more. The same mass fraction may be, for example, 75% or less, 50% or less, 25% or less, or 10% or less.

### First Active Material Particle

The first active material particles 21 include graphite. The first active material particles 21 may include natural graphite or artificial graphite. The first active material particles 21 may contain additional components as long as they contain graphite. The first active material particles 21 may further contain, for example, soft carbon, hard carbon, amorphous carbon, or the like. For example, amorphous carbon may be adhered to the surface of graphite. The mass fraction of graphite in the first active material particles 21 may be, for example, 50% or more, 75% or more, 90% or more, or 95% or more.

The first active material particles 21 are oriented in the thickness direction. The first active material particles 21 have a first orientation angle (θ1). The first orientation angle (θ1) is 50° or more. The first orientation angle (θ1) may be, for example, 52° or more, 54° or more, 58° or more, 62° or more, 63° or more, or 66° or more. The first orientation angle (θ1) may be, for example, 90° or less, 80° or less, or 70° or less.

The aspect ratio of the first active material particles 21 may be, for example, 1.3 or more, 4.3 or more, 8.2 or more, 9.5 or more, or 13.5 or more. The aspect ratio of the first active material particles 21 may be, for example, 20 or less, 15 or less, 13.5 or less, or 9.5 or less.

The particle size of the first active material particles 21 may be, for example, 5 μm or more, 10 μm or more, 15 μm or more, 30 μm or more, 45 μm or more, or 60 μm or more. The particle size of the first active material particles 21 may be, for example, 75 μm or less, 60 μm or less, 45 μm or less, or 30 μm or less.

### Second Active Material Particle

The second active material particles 22 contain Si. The second active material particle 22 may contain an additional component as long as it contains Si. The second active material particles 22 may contain, for example, at least one selected from the group consisting of Si, Si-based alloys, silicon oxide (SiO), and Si—C. “Si—C” refers to a composite material comprising Si and carbon (C). In Si—C, Si may or may not form a compound with C. C may be amorphous or crystalline. For example, the carbon particles may support Si. The amount-of-substance fraction (mole fraction) of Si in the second active material particles 22 may be, for example, 5% or more, 10% or more, 25% or more, 50% or more, 75% or more, 90%, or 95% or more.

The second active material particles 22 may include, for example, the core particles 1 and the magnetic material 2. The core particle 1 may contain, for example, at least one selected from the group consisting of Si, Si-based alloy, SiO, and Si—C. The core particles 1 may be primary particles or secondary particles. The magnetic material 2 has a magnetic field response. The magnetic material 2 may include, for example, at least one selected from the group consisting of Ti, Zr, and V. The magnetic material 2 is adhered to at least a part of the core particle 1. The magnetic material 2 may be contained in the core particle 1 (secondary particle), for example. The magnetic material 2 may cover the surface of the core particle 1, for example. The magnetic material 2 may have, for example, a film shape or a particle shape (island shape). For example, the core particles 1 may be coated with the magnetic material 2 by barrel sputtering. The coverage may be, for example, 12% or more, 35% or more, 38% or more, 41% or more, or 43% or more. The coverage may be, for example, 100% or less, 75% or less, or 50% or less.

The second active material particles 22 are also oriented in the thickness direction. The second active material particles 22 have a second orientation angle (θ2). The second orientation angle (θ2) is 35° or more. The second orientation angle (θ2) may be, for example, 37° or more, 43° or more, 46° or more, 47° or more, 49° or more, or 51° or more. The second orientation angle (θ2) may be, for example, 90° or less, 80° or less, 70° or less, or 60° or less.

The orientation angle ratio (θ1/θ2) may be, for example, 1.41 or less, 1.40 or less, 1.27 or less, 1.26 or less, or 1.24 or less. The orientation angle ratio (θ1/θ2) may be, for example, 1 or more, 1.1 or more, 1.2 or more, or 1.24 or more.

The aspect ratio of the second active material particles 22 may be, for example, more than 1, 1.1 or more, 1.2 or more, 1.5 or more, 2 or more, 3 or more, 4 or more, or 5 or more. The aspect ratio of the second active material particles 22 may be, for example, 10 or less, 7.5 or less, or 5 or less.

For example, the second active material particles 22 may have a particle size smaller than that of the first active material particles 21. The particle size of the second active material particles 22 may be, for example, 0.5 μm or more, 1 μm or more, 1.5 μm or more, 3 μm or more, or 4.5 μm or more. The particle size of the second active material particles 22 may be, for example, 12 μm or less, 9 μm or less, or 6 μm or less.

### Other Components

The negative electrode active material layer 20 may further include a conductive material, a thickener, a binder, and the like in addition to the negative electrode active material. The conductive material may form an electron conduction path. The conductive material may include, for example, at least one selected from the group consisting of acetylene black (AB), Ketjen black (registered trademark), vapor-grown carbon fiber (VGCF), carbon nanotubes (CNT), and graphene flakes (GF). The blending amount of the conductive material may be, for example, 0.1 to 10 parts by mass with respect to 100 parts by mass of the negative electrode active material.

The thickener may impart viscosity to the negative electrode paste. The thickener may include, for example, at least one selected from the group consisting of sodium alginate, carboxymethyl cellulose (CMC), polyacrylic acid (PAA), and polyvinylpyrrolidone (PVP). The blending amount of the thickener may be, for example, 0.1 to 10 parts by mass with respect to 100 parts by mass of the negative electrode active material.

The binder may bind the solids together. The binder may contain, for example, at least one selected from the group consisting of styrene-butadiene rubber (SBR), acrylate-butadiene rubber (ABR), polyacrylonitrile (PAN), polyvinylidene difluoride (PVdF), polytetrafluoroethylene (PTFE), an acrylic resin (acrylic acid ester copolymer), a methacrylic resin (methacrylic acid ester copolymer), and polyvinyl alcohol (PVA). The blending amount of the binder may be, for example, 0.1 to 10 parts by mass with respect to 100 parts by mass of the negative electrode active material.

### Examples

### —Preparation of Sample—

### No. 1

Graphite (aspect ratio: 3.1) was prepared as the first active material particles. A Si-based material (Si or SiO) was prepared as the second active material particles. The first active material particles, the second active material particles, the SBR, the CMC, and the ion exchanged water were mixed to prepare a negative electrode paste. The solid formulation was “Graphite:Si-based material:SBR:CMC=(98.3−a):a:0.5:1.2 (mass ratio)”. A Cu foil (thickness: 10 μm, long strip) was prepared as a substrate. The negative electrode paste was applied to both surfaces of the substrate to form a coating film. The coating film was dried to form a negative electrode active material layer. The negative electrode active material layer was compressed to produce an electrode (negative electrode sheet). In the negative electrode sheet, the first orientation angle (θ1), the second orientation angle (θ2), and the like were measured by the above-described procedure.

An evaluation cell (lithium ion battery) was prepared by the following procedure. A positive electrode paste was prepared by mixing LiNi_{1/3}Mn_{1/3}Co_{1/3}O₂ (particle size: 5 μm), AB, PVdF, and N-methyl-2-pyrrolidone. The solid content was “LiNi_{1/3}Mn_{1/3}Co_{1/3}O₂:AB:PVdF=92:5:3 (mass ratio)”. An Al foil (thickness: 15 μm, long strip) was prepared as a substrate. The positive electrode paste was applied to both surfaces of the substrate to form a coating film. The positive electrode active material layer was produced by drying the coating film. The positive electrode active material layer was compressed to form a counter electrode (positive electrode sheet).

A separator was provided. The separator included a porous resin film and a heat-resistant layer. The porous resin film (thickness: 24 μm) had a three-layer structure (polyethylene layer/polypropylene layer/polyethylene layer). The heat-resistant layer (thickness: 4 μm) was formed on one surface of the porous resin film.

A stack was formed by stacking the positive electrode sheet, the separator, the negative electrode sheet, and the separator. The stack was spirally wound to form a wound power generating element (This is also referred to as an “electrode assembly”). The power generating element was formed into a flat shape by being crushed in the radial direction. An external terminal is connected to the power generating element. The power generating element was housed in a metal case. The electrolyte solution was injected into the metal case. After the electrolyte solution was injected, the metal case was sealed. Thus, the evaluation cell was manufactured. The composition of the electrolyte solution was as follows.
Solvent: “ethylene carbonate:dimethyl carbonate:ethyl methyl carbonate=3:3:4 (volume ratio)”
Solute: LiPF₆ (concentration: 1 mol/L)

Initial charge and discharge (activation treatment) was performed under the following conditions.
Ambient Temperature: 25° C.
Charging: constant current-constant voltage system, current at constant current: ⅓ C, voltage at constant voltage: 4.2 V, Cut Current: 1/50 C
Discharging: constant current system, current: ⅓ C, cut voltage: 3V

### No. 2

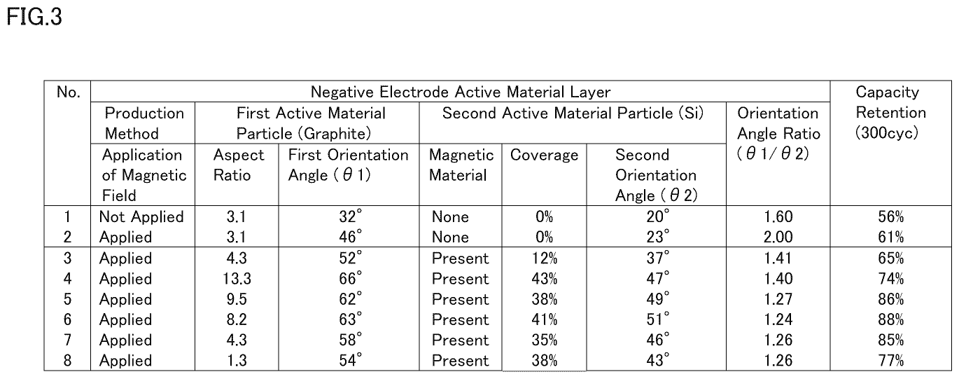

FIG. 3 is a table showing experimental results. In No. 2, graphite (aspect ratio: 4.3) was used as the first active material particles. A negative electrode paste was prepared in the same manner as in No. 1. The negative electrode paste was applied to both surfaces of the substrate to form a coating film. In No. 2, after the coating film was formed, a magnetic field was applied to the coating film by passing the coating film through the gap between the pair of neodymium magnets. The magnetic flux density of the magnet was 0.5 T. After the application of the magnetic field, the coating film was dried to form a negative electrode active material layer. Except for these, an electrode and an evaluation cell were produced in the same manner as in No. 1.

### No. 3

In No. 3, graphite (aspect ratio: 13.3) was used as the first active material particles. The second active material particles were coated with the magnetic material by barrel sputtering. The coverage was 12%. An electrode and an evaluation cell were produced in the same manner as in No. 2, except that the second active material particles after coating were used.

### No. 4 to No. 8

As shown in FIG. 3, an electrode and an evaluation cell were produced in the same manner as in No. 3, except that the aspect ratio of the first active material particles and the coverage of the second active material particles were changed.

### —Evaluation—

### Measurement of Initial Capacity

The initial capacity (initial discharge capacity) was measured by charging and discharging under the following conditions.
Charging: constant current-constant voltage system, current at constant current: ⅓ C, voltage at constant voltage: 4.1 V, Cut Current: 1/50 C
Discharging: constant current system, current: ⅓ C, cut voltage: 3V

### Cycling Performance

Charging and discharging under the following conditions was performed as one cycle, and 300 cycles of charging and discharging were performed.
Ambient Temperature: 25° C.
Current: 0.5 C
Range of state of charge (SOC): 0% to 100%

After 300 cycles, the post-cycle capacity was measured, similar to the initial capacity. The capacity retention was determined by dividing the post-cycle capacity by the initial capacity. It is considered that the higher the capacity retention, the better the cycle endurance.

### —Results—

In the table of FIG. 3, No. 3 to No. 8 have improved cycle endurance as compared with No. 1 and No. 2. In Nos. 3 to 8, the first orientation angle (θ1) is 50° or more, and the second orientation angle (θ2) is 35° or more.

In Nos. 3 to 8, when the aspect ratio of the first active material particles is 4.3 to 9.5, the cycle endurance tends to be improved.

In Nos. 3 to 8, when the first orientation angle is 58° or more, the cycle endurance tends to be improved.

In Nos. 3 to 8, when the coverage is 35% or more, the cycle endurance tends to be improved.

In Nos. 3 to 8, when the orientation angle ratio is 1.40 or less, the cycle endurance tends to be improved.

What is claimed is:

1. An electrode comprising:
a substrate; and
a negative electrode active material layer, wherein
the negative electrode active material layer is disposed on a surface of the substrate,
the negative electrode active material layer includes a first active material particle and a second active material particle,
the first active material particle includes graphite,
the second active material particle includes silicon,
in a cross section parallel to a thickness direction of the negative electrode active material layer,
the first active material particle has a first orientation angle of 50° or more,
the second active material particle has a second orientation angle of 35° or more,
the first orientation angle indicates an angle formed between a major axis of the first active material particle and the surface of the substrate, and
the second orientation angle indicates an angle formed between a major axis of the second active material particle and the surface of the substrate.

2. The electrode according to claim 1, wherein
the second active material particle includes a core particle and a magnetic material,
the core particle includes silicon, and
the magnetic material is adhered to at least a portion of the core particle.

3. The electrode according to claim 2, wherein the magnetic material includes at least one selected from a group consisting of titanium, zirconium, and vanadium, and
a ratio of an adhesion area of the magnetic material to a surface area of the second active material particle is 35% or more.

4. The electrode according to claim 1, wherein the first active material particle has an aspect ratio of 4.3 to 9.5.

5. The electrode according to claim 1, wherein
the first orientation angle is 58° or more, and
a ratio of the first orientation angle to the second orientation angle is 1.40 or less.
